(19) United States
(12) Patent Application Publication
(10) Pub. No.: US 2003/0229510 A1
(43) Pub. Date: Dec. 11, 2003

(54) Discriminating network recruitment system

(76) Inventor: Jason Kerr, Auckland (NZ)

Correspondence Address: WOOD, HERRON & EVANS, L.L.P., 2700 Carew Tower, 441 Vine St., Cincinnati, OH, 45202, US

(21) Appl. No.: 10/441,433

(22) Filed: May 20, 2003

Related U.S. Application Data
(60) Provisional application No. 60/382,252, filed on May 21, 2002.

(51) Int. Cl. G06F 17/60

(52) U.S. Cl. 705/1

(57) ABSTRACT

A method, apparatus and program product streamline hiring processes by programmatically discriminating between prospective employees. The system may achieve such discrimination by subjecting a prospective employee to a detailed, second tier of evaluation processes particular to a designated employer only after an initial determination confirms their relative employability with regard to criteria submitted by a employer.

### CROSS-REFERENCE TO RELATED APPLICATION

This application claims the benefit of U.S. Provisional Application No. 60/382,252 filed on May 21, 2002, and the disclosure of which is hereby incorporated by reference herein.

### FIELD OF THE INVENTION

The present invention relates generally to computer operations, and more particularly, a computer-implemented recruiting evaluation process conducted over a networked environment.

### BACKGROUND OF THE INVENTION

Recruitment, in one respect, broadly regards the matching of qualified personnel resources with current and future employment needs. Traditionally, recruitment has been accomplished by employers advertising job postings in newspapers, trade magazines, flyers, the Internet and other known mechanisms of publication. Employers receive letters, facsimiles, or other electronic responses and resumes from prospective employees. Employer offices typically open, copy/print, catalog and forward the responses to appropriate hiring personnel in a folder created for each prospective employee. In some instances, the sheer volume of applicant responses and associated hiring processes can become staggering. As the workplace becomes more specialized, conventional recruitment practices represent a significant drain on budgets, manpower, and other resources of commercial and government enterprises.

Moreover, costs of some known recruitment resources may prove cost ineffective or preclusive in certain contexts. For instance, headhunter agencies, consultants and recruitment/placement firms retained by companies to locate talent typically receive a stipend or percentage of a recruit's starting salary. Such fees may account for a significant portion of an operating budget. Likewise, advertisements, postage, telephone costs, man hours and other costs associated with pre-application processes can burden employers, even prior to initial evaluation of a prospective employee. Other costs may regard man hours expended to prepare, explain and distribute applications and other requirements of an application process.

In addition to expense considerations, associated recruitment processes can span several months. Such long time frames may contribute to frustration and lost opportunity for both employers and prospective employees. For instance, an employer interested in a prospective applicant may fail to timely contact the applicant prior to the prospective employee accepting a position with another employer. In this manner, most recruitment processes may be categorized as being merely reactive to requirements. Consequently, associated lag times may be unavoidable in conventional systems.

Once an application and/or resume is received by an employer, it must typically be opened, initially reviewed and sorted. Even electronic transmissions are conventionally printed out onto hard copy and distributed through normal internal mail-routing conventions. Vast amounts of data attributable to large amounts of applicants can compound time requirements needed to file, record, distribute and otherwise respond to data. Often the information received from prospective employees is incompatible with a particular format required by a particular employer. As such, the information must be disregarded or re-accomplished in the requisite format. For example, personnel may reenter information originally supplied by the applicant into a database. Such practices further contribute to costs and delay.

Moreover, headhunting and consulting agencies often used to initially locate prospective employees tend to be too broadly focused for some recruiting applications. For instance, a recruitment company may focus on a prospective employee base having the most generically transferable job skills. Such focus may elude specific job requirements of certain employers requiring an important, but nonetheless relatively unique skill set. Moreover, such lack of focus may translate into an employer receiving many applicants who can not meet minimum requirements. As a result, an employer may become inundated and overwhelmed by a number of unqualified applicants. Additionally, recruitment professionals may introduce biases into application processes. A headhunter may have a preference or a misconception that is inconsistent with specifications of a represented employer or even another headhunter. Consequently, threshold criteria can vary dramatically from those attributes desired for a given position vacancy.

Even during actual evaluation processes, hiring practices can present substantial obstacles to a hiring infrastructure. For instance, personnel must typically contend with management of interview notes. Such notes may be loose leaf and submitted by numerous interviewers over varying time frames. For fairness and accuracy, it may be desirable to incorporate the notes into the applicant's file and/or transcribe them into a database or comparable filing system. Many such processes lend themselves towards subjectivity. Similar to the professional recruitment services discussed above, different hiring personnel within the same company may apply disparate criteria to interviewees. Thus, inconsistent standards may flaw an entire recruitment process even after initial screening.

Known recruitment processes face similar obstacles with regard to updating information relating to a prospective employee. Where the address, qualifications or other information pertaining to an applicant changes over the course of an application process or other period, employers must typically open, review and sort the updated data in addition to retrieving the original application file for the prospective employee. It may then be incumbent upon the employer to substitute or otherwise highlight the updated data. Such processes further introduce potential for error and accumulating costs.

Consequently, and for in part the above delineated reasons, there exists a need for an improved manner of recruiting skilled personnel.

### SUMMARY OF THE INVENTION

The present invention provides an improved apparatus, method and program product for recruiting skilled personnel. One embodiment may streamline hiring processes by evaluating data submitted over a network interface using software configured to discriminate between potential applicants. An initial evaluation of all candidates against a core template of questions may focus an applicant pool. Only those prospective employees of the pool having qualifications meeting or exceeding those of a threshold standard continue on within a recruitment process. For instance, only those applicants having a minimum score may warrant subsequent evaluation. Such testing may comprise a detailed, second tier of questions and/or tasks particular to a designated employer. Responses to such second tier questions may be similarly evaluated to arrive at a composite rating and/or ranking indicative of an applicant's suitability for hire.

By virtue of the foregoing there is thus provided an improved recruitment mechanism that streamlines hiring processes in a manner that addresses above-identified shortcomings of known networked systems. These and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate an embodiment of the invention and, together with a general description of the invention given above, and the detailed description of the embodiment given below, serve to explain the principles of the invention.

FIG. 1 is a network environment consistent with the principles of the present invention;

FIG. 2 is an exemplary browser window configured to assist a prospective employee in establishing an account within the network environment of FIG. 1;

FIG. 3 is an exemplary browser window configured to prompt exemplary core information from the prospective employee within the network environment of FIG. 1;

FIG. 4 is an exemplary browser window configured to assist the prospective employee within the network environment of FIG. 1 in locating a suitable employer;

FIG. 5 is a block diagram of a networked computer system consistent with the invention;

FIG. 6 is a block diagram of an exemplary hardware and software environment for a computer from the networked computer system of FIG. 1;

FIG. 7 is flowchart outlining method steps initiated by program code within the hardware systems of FIGS. 1 and 5-6; and

FIG. 8 is flowchart outlining method steps initiated by a prospective employer within the hardware systems of FIGS. 1 and 5-6.

### DETAILED DESCRIPTION OF DRAWINGS

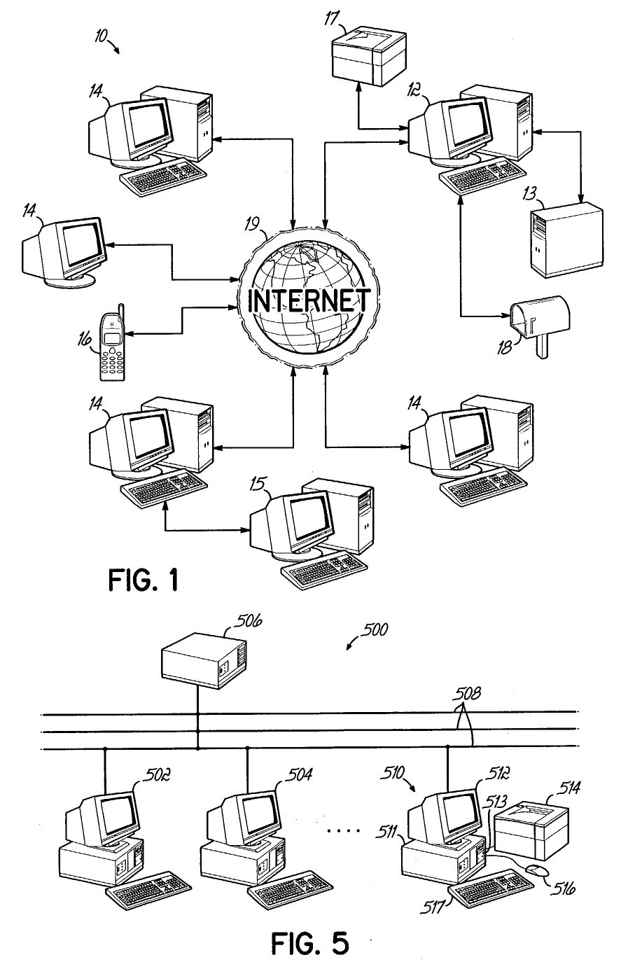

With reference generally to FIGS. 1, 5 and 6, there are shown exemplary computer implemented recruiting systems 10, 500 and 600 configured in accordance with principles of the present invention. In one respect, configurations of the systems 10, 500 and 600 may streamline, automate and standardized aspects of a recruitment process. Program code 512 may enable an employer to focus recruiting processes on those prospective employees meeting qualifications preset by the employer. Embodiments may capitalize on web interface technologies to provide comprehensive management resources to both employers and employees. Another or the same embodiment may limit an Internet recruitment process to a specific industry to realize other efficiencies and advantages discussed below.

FIG. 1 shows generally an exemplary system 10 that includes user computers 14, 15 and/or other network devices 13, 16, 17 enabling prospective employees and employers to communicate with and through one or more centralized servers. To this end, program code incident at any one or all of the computers 14, 15 and/or server(s) 12 may facilitate the exchange of hiring information. Data transmissions may typically be conducted via a web-based interface supported by the Internet 19, an intranet, ethernet or other network system. Of note, program code of the system 10 may automatically generate a suitable web-based interface at the server 12 in response to criteria submitted by one or more employers. For reasons of efficiency and accuracy, employers submitting criteria typically conduct business within the same market. For instance, all employers submitting data to the server may compete within the airline or nursing industry. As discussed below, such “vertical” focus of participating employers may allow for more selective and thorough recruitment processes.

The criteria submitted by the employer and subsequently presented to a prospective employee typically reflects such selectivity. Exemplary criteria may be prompted by program code installed at the computer 14 of an employer or executing at the server 12. In some instances, criteria may be automatically submitted and/or offered for the consideration of the employer based on stored questions and/or tasks. As such, submitted criteria may relate to core competency skills considered generic to an entire industry or to a specific aspect of the same. For example, most employers in a given field of endeavor may consider skills such as years of experience and training to be relevant to an applicant's employability. As such, program code incident at the server 12 may group and store criteria relating to such common, core skills. The program code may generate a working question template generic to the industry and based on the criteria. Of note, the system 10 may store the criteria and/or template within a database 13 or other memory accessible to the program code. Other criteria submitted by employers and possibly included within a core listing of criteria may regard personal information of applicants. Such personal information may be configured to prompt the name, residence, electronic and postal mail addresses, hobbies and preferences of prospective employees, among other attributes.

Still other employer criteria sent to the server and intended for employees may concern questions particular to the specific culture and/or unique to the operating environment of the employer. As such and for purposes of this disclosure, suitable employer criteria may comprise any question or task presentable to a prospective employee over a computer interface and/or other communication medium/process that is initiated by program code. For instance, criteria may include an online test to be completed by an applicant, such as a psychological profile exam available through Mariner7.com Inc. As discussed herein, certain such criteria may be reserved for only those prospective employees that preliminarily qualify. Such qualification may be established based upon a programmatic evaluation of applicant responses to questions derived from core competency criteria. This feature may reduce incidences of an employer becoming inundated with applications that fail to meet minimum and/or preset conditions.

In one embodiment, qualification processes may regard a multiplier or mathematical weight (scaled value) assigned to and submitted along with the criteria. The multiplier may attach to criteria and assist in rating applicants. More particularly, multipliers may be used in calculations to categorize aspects of an applicant's employability. Program code installed by the employer may prompt a selection of a multiplier in response to the employer submitting a criterion. For instance, the employer may indicate that a willingness to move to a particular geographic region could affect employability. In another example, an employer may submit criteria prescribing a minimum number of years of experience.

In accordance with an aspect of the present embodiment, program code may encourage the employer to select a level of importance to be assigned to the criteria. For instance, the employer may choose one descriptor from a list displayed in a pull-down window: “very important, important, meaningful, standard and inconsequential.” Each descriptor may correlate to a mathematical value useful in subsequent calculations. Another web interface may prompt an employer to type in or otherwise designate an integer or decimal value to be assigned to the relative importance of the question prompting the applicant input. In this vein, another or the same embodiment may prompt the employer to rank criteria with respect to the import attributed to other criteria. As such, submitted criteria may convey to the server an additional layer of information that may allow for greater flexibility and tailoring tuned to both general industry qualification and any specific desires of a particular employer.

More particularly, program code may solicit weighting by the employer regarding potential answers by the applicant to questions derived from the criteria. To this end, the program code may present the employer with a pull-down listing or table of stored answers that are to be presented to a prospective employee responding the question. For instance and continuing with the above example, potential answers available to an applicant prompted to enter years of experience in a field may include ranges of 1-2 years, 2-4 years and over 4 years. The applicant may select an appropriate field by clicking on a button or other interface mechanism configured to select a presented option.

Each range may have another multiplier or mathematical factor attached that remains associated with applicant responses through subsequent evaluation processes. As above, the factor may be correlated to a relative, textual qualifier describing the relative importance of the answer. For instance, an employer may designate “over 4 years” experience as being “very important” or “essential.” To this end, web interfaces consistent with the principles of the present invention typically incorporate stored answers that are recalled and presented in preset menus. As such, an applicant may reply by merely designating a stored response. Thus, such a configuration of stored responses may lend itself to association with a weighting factor.

Program code at the server 12 may receive the criteria, stored responses and/or associated weighting. The program code may subsequently translate it into questions presentable to prospective employees. Of note, the information transmitted from each employer may additionally include preferences relating to color, fonts, layout and overall presentation of a web interface to accompany employer questions. In any case, the criteria typically arrives at the server 12 over a standard Internet connection. Software at the client/employer computer may ensure compatibility of formats as between the submitted criteria and other information and the processing software at the server. As discussed herein, the server may receive similar criteria and related information from other employers in the same field of endeavor. The system may thus correlate criteria submitted by the employers to realize trends and efficiencies afforded through detected commonality.

In one embodiment, program code may construct at least one web interface at the server 12 that may account for the submitted criteria, stored responses, associated weighting and other information. Program code will typically generate a matrix of core competency questions derived from common criteria as submitted across the spectrum of employers. This feature is facilitated by virtue of the employers participating in a common field. Thus, an exemplary grouping of core questions may comprise a relatively large number of questions relevant to hiring considerations of a majority of employers. For example, a majority of employers submitting criteria to the server may require applicants to indicate a willingness to relocate. As such, at least one question relating to relocation may be included along with other core questions occurring with a preset frequency. Such a core list of questions may be presented to an applicant as a preliminary matter. That is, the web interface may initially prompt prospective employees to fill out required fields of a template comprising the core questions. Of note, a suitable collection of initial, or core questions, may include questions relating to personal information of a prospective employee. Such personal data may comprise contact information, interests and goals, as well as health and family history, among other considerations.

Program code may further be configured to create a listing of employer-specific questions accounting for criteria submitted by an employer that fall outside the scope of those questions considered core, or standard, throughout the industry. Such questions may relate to the culture and work environment of the employer, and may be more directed at finding a personality “fit” for the organization. Such questions could relate to a preference for casual dress over formal attire, a willingness to participate in team building exercises, and/or a reluctance to work for an inexperienced manager.

Another or the same embodiment may include a technical knowledge or skills test, another task may solicit a writing sample. As discussed above, another employer-specific and/or core data may include a psychological profile exam. Any exam discussed in the context of the present invention may be accomplished realtime and/or online, where appropriate. For instance, a prospective employee may have a preset period of time to complete a series of questions presented via a web interface after clicking on a “Begin Test” button or other link. Moreover, an examination of one embodiment of the present invention may include accessing information remotely stored at another website that may link to a primary browser window in a manner that is consistent with the invention. In any case, the inclusion, design and presentation of employer-specific questions may vary according to employer preferences.

As such, respective fields of the web interface may correspond to either or both displayed questions and preprogrammed answer selections. In one embodiment, the respective fields may link to associated multipliers/factors. In this manner, an applicant's designation of field associated with an answer to a core and/or employer-specific question may initiate retrieval of the associated factor/scaled value. The recalled factor and scaled value may subsequently be processed by program code to determine a score for the prospective employee, as discussed below. In this manner, the web interface layout may preserve, account for and realize relative weighting assigned and submitted by the employer for respective questions and responses.

Where appropriate, program code may initiate display of the stored answers correlated to individual questions via the web interface. As such, applicants may click-on, highlight, speak or otherwise designate a proffered response. For instance, an applicant may use a computer mouse to click on an appropriate browser field. Some embodiments consistent with the principles of the present invention may allow a prospective employee to type responses into text fields. Evaluation of such text could be accomplished manually by the employer or automatically by recognition software known to detect entered keywords. As with the preprogrammed responses, a glossary of such keywords may be correlated to mathematical multipliers useful in calculating a mathematical rating indicative of the applicant's employability.

A prospective employee may access the web interface via any standard network connection. Accessibility of the Internet may lend particular application to embodiments of the invention by removing obstacles that might otherwise discourage applicant participation. In this vein, one embodiment may encourage initial use by prospective employees by waiving application and/or sign on fees associated with logging in to the web interface and/or applying to a first employer. Upon accessing the web interface, the prospective employee may be prompted to set up an account, typically involving known password or other security software processes. Account access and information may thus be under the exclusive control of the prospective employee and the server administrator.

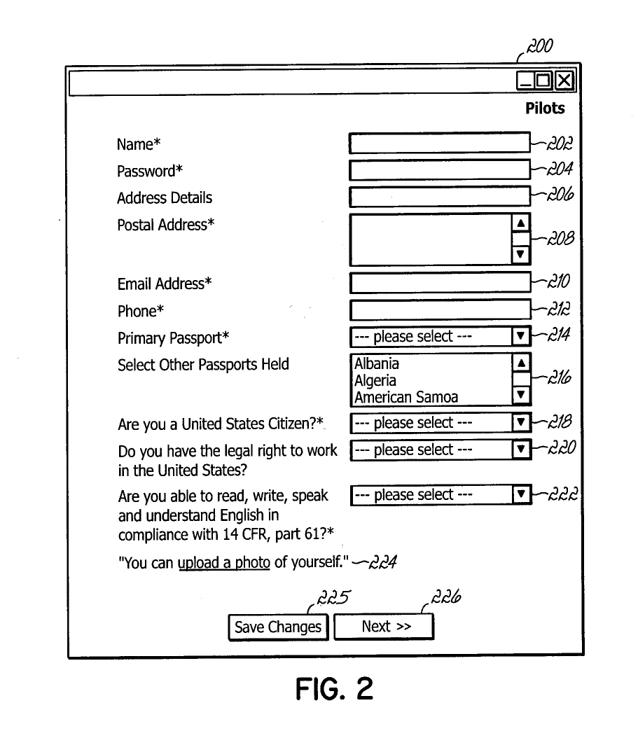

FIG. 2 shows an exemplary browser window 200 configured to assist a prospective employee in establishing an account. For instance, the browser window 200 includes text fields 202-212 for receiving the name and other contact information for the prospective employee. Access to the account of the prospective employee may be password protected, as accommodated by field 204 of FIG. 2. Other exemplary fields 214-222 of FIG. 2 are directed to ascertaining the citizenship, as well as travel and language status of prospective employees. Certain fields 202, 204, 208-214, 218 and 222 of the browser window 200 may be designated as requiring input by prospective employees. Text of the exemplary browser window 200 of FIG. 2 for prompting such input includes asterisks for the benefit of the prospective employer.

Other input mechanisms of the browser window 200 may be optional, such as a hyperlink 224 initiating the submission of a digital photograph of the prospective employee. The prospective employee may advance to the next browser window by clicking on “Next” 226. Advancement to the next browser window in one embodiment that is consistent with the invention may automatically save the input data. Alternatively, a user may select a “Save Changes” button 225 to save selectively updated data using the browser window 200 and without advancing to a subsequent screen containing previously entered and unchanged data. Computer storage processes consistent with the invention may ensure that all such updated employee and/or employer data is immediately available for consideration and subsequent processing.

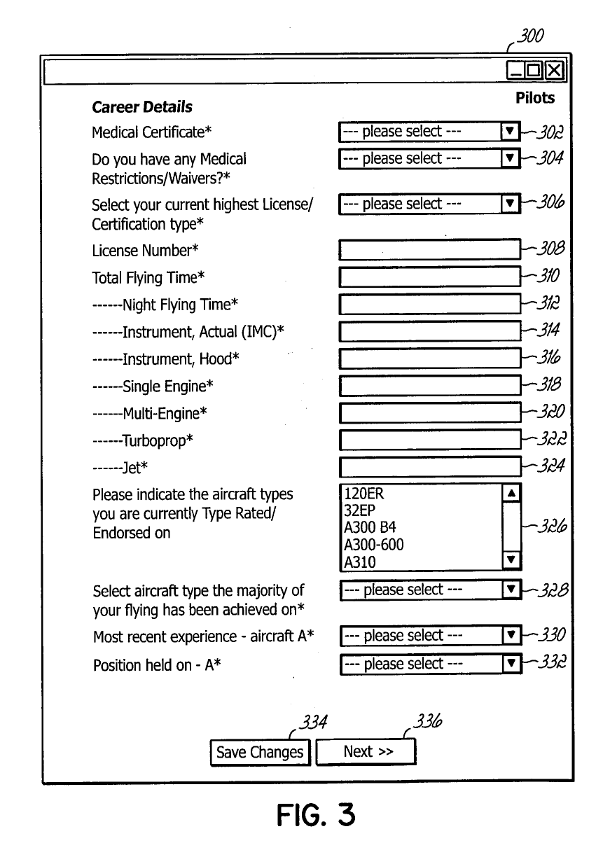

Upon establishing their account, the prospective employee may initially be challenged with a display of core competency and/or personal questions. That is, program code may prompt the applicant to submit responses to a set of questions having some, if not universal, application with respect to participating employers. FIG. 3 shows an exemplary browser window 300 suited to prompt exemplary core information from prospective employees applying for positions within an airline industry. More particularly, the browser window 300 of FIG. 3 enables a prospective pilot employee to enter data relating to their career experience and goals at fields 302-332. As above, program code may ensure compliance of applicant responses prior to allowing the data to be submitted. For example, prospective employees may have to respond to all fields having an asterisk before the program code will advance the applicant to a next window. This feature may avoid certain scenarios that can plague conventional hiring processes, such as where an employer begins reviewing application data of a prospective employee only to subsequently discover the omission of key data. Such an oversight can largely nullify the prior evaluation and at least introduce inefficiency into a hiring process. One of skill in the art will appreciate that the fields of another exemplary browser window that is consistent with the invention may include both core and general questions as desired.

By virtue of the core question template being generic across a spectrum of participating employers, one embodiment of the system may be configured to promote, or transfer, the employee responses to core or any other to all designated employers and/or web-based interfaces consistent with the invention without requiring the prospective employee to reenter responses. Thus, the web interface may spare the prospective employees from having to re-accomplish application processes where possible.

As such, the responses, as well as all other communications between the applicant and an employer, may be cataloged for future reference of the system and the prospective employee. In this manner, one embodiment may exploit software features of the Internet and/or supporting computer network by allowing the prospective employee to use their account as a management center. That is, after initially applying to an employer(s), the prospective employee may continue to reference their account to check for responses from an employer, to receive reminders to update their data, to apply to additional employers or respond to further questions/tasks by the same employer. Program code driving the web interface may additionally provide features such as management of scanned documents, certified documents, licenses and handwriting samples. Other features may enable chatroom technologies, interactive email, streaming video and real time examination software as required by employers. An exemplary interface may record a log of hiring actions taken within the system and automatically notify the applicant of incoming requirements or announcements from employers. Where configured as such, prospective employees may view evaluation data generated from the employer via the web interface.

At some point after or prior to completing core questions at the interface, the prospective employee may designate one or more employers whom they wish to consider their data. In one embodiment, an initial screen may prompt a prospective employee to select one or more designated employers from the onset of an application session, such as after logging in. For privacy and account management considerations, the program code typically will not share data with or otherwise make it accessible to a non-designated employer. In one embodiment, a prospective employee may further designate only a portion of available employers, but permit additional employers to view and respond to their data in turn. As such, an employer searching for available personnel may be permitted to view the applicant's qualifications and invite them to apply directly.

Another feature of an embodiment consistent with the principles of the present invention may permit a prospective employee to selectively prevent one or more individual employers from viewing the data. For instance, a prospective employee may designate all employers in the field, save one or two whom the applicant does not wish to apply at the time of submission. Such a feature may have particular application where a prospective employee has no intention to work for a particular company, or perhaps is already working for the company and does not want to alert their current employer.

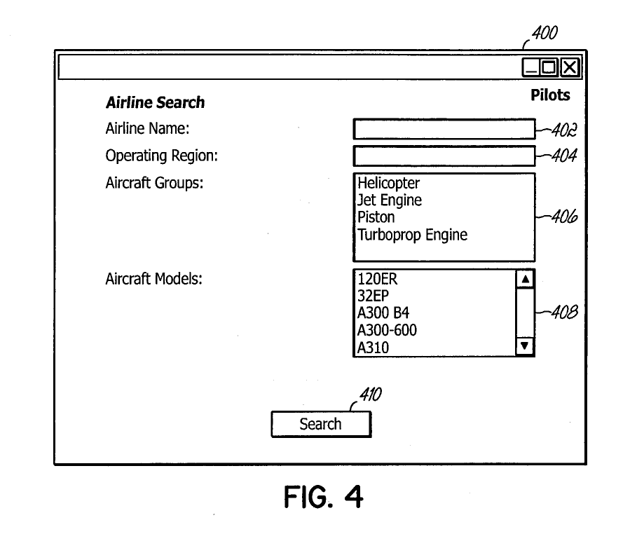

Still another feature of the same or another embodiment may permit a prospective employee to select or block application to employers based on other considerations. For instance, program code may prompt a pilot to input the type of aircraft they desire and/or are qualified to fly. In response, the program code may automatically select a list of suitable airlines having the specified aircraft or other asset, accordingly. An exemplary browser window 400 suited to prompt and communicate such data is shown in FIG. 4. For instance, a pilot candidate may designate a preferred airline company at field 402 and/or a desired operating region at field 404 of FIG. 4. A user may also enter aircraft group and model preferences at fields 406 and 408, respectively, prior to initiating a search by clicking on a link 410. As with all exemplary embodiments discussed herein, one of skill in the art will appreciate that the underlying principles of the present invention can apply to any field of endeavor, and is not limited to airline employment applications.

Program code incident at the server may initially evaluate submitted responses to core questions. Such an evaluation may include assigning a score or other rating to the applicant. Exemplary rating processes may include a matrixing algorithm configured to generate a score based on a multiplier, or scaled value, correlated to an employment criterion and a second multiplier, or factor, assigned to the response. For instance, a response to a question may merit an average weighting factor, i.e., five out of ten. This integer may then be multiplied by another scaled value, eight, assigned to the question. The scaled value may reflect its relative importance to the employer. As such, the entire response of the applicant may register as 40 points. Other responses may similarly be processed to arrive at respective scores. Such scores may function to quantify differences between prospective employees. Moreover, the difference may be tailored to accentuate those aspects deemed most important to a particular employer. Program code may then aggregate or otherwise process all or some of the scores to arrive at core rating for the applicant. This core rating may then be compared against an employer threshold or standard score for one or more employers designated by the prospective employee.

The threshold score may function to initially discriminate among the qualifications and appropriateness of prospective employees. That is, those applicants having scores higher than the threshold score should consist of a group having at least those minimum requirements deemed desirable or essential by the employer. Conversely, those applicants whose scores do not equal or exceed the threshold value may be programmatically grouped and tagged as such. Dividing the candidate pools in this manner may facilitate more focused and discriminating hiring processes by relieving parties of needless evaluation and submissions. For instance, one embodiment may immediately notify a prospective employee via email, phone and/or letter that they will not further be considered for the job. Such response time contrasts comparable response periods of known systems, and may provide the applicant with near instant feedback. Such feedback may immediately communicate to the prospective employee an indication of how their qualifications match an employer matrix of qualifications.

Of note, while manipulating the product of multipliers assigned to questions and responses to arrive at a score or applicant rating may have particular processing advantages, one skilled in the art should nonetheless appreciate that any other mechanism of assessing the relative employability of an applicant may be substituted in embodiments of the present invention while still remaining consistent with the principles of the present invention. That is, the initial evaluation process utilized to assess the core competency of the prospective employer should not be construed to interfere with the results of the evaluation being programmatically compared with a threshold value. Moreover, the evaluation criteria is not central to determining whether the employer will prompt additional responses from the prospective employee.

Further, it should be understood that certain responses may be scaled or weighted separately from others or groups of others. For instance, it may be critical to an employer that an prospective employee be willing to move to the United States. Program code configuration may treat a response to question as such in a different manner than with other, less critical responses. While such an affect can be achieved with disproportionate weighting, a suitable embodiment may alternatively treat the response as a separate, binary test independent of other evaluation criteria.

From the perspective of an employer, the initial screening at the server may function to dramatically reduce the number of unqualified applicants conventionally received during the course of a hiring process. As such, an embodiment may obviate the need for employers to initially consider applicants, as program code at the server may first intercept and act without the employer's knowledge. Such discrimination may translate into more efficient recruitment processes by virtue of the employer being able to focus on only those candidates meeting the preset requirements. Such efficiency may further be achieved with lower operating costs for the employer attributable in part to reduced applicant volume.

Where program code at the server determines that the score of the applicant meets the threshold requirements stipulated by the designated employer, the program code may recall and initiate a display of the employer-specific questions/tasks via the web interface. As discussed above, such a display may prompt additional data from the applicant. The additional data may be unique to the hiring process and working environment of the designated company. For instance, the applicant may be asked to submit a writing sample or health records, or indicate whether they play golf or softball. Where appropriate, applicant responses to these “second tier” questions may be evaluated in a fashion similar to those responses to the core questions. That is, the product of multipliers assigned to respective questions and answers may be further processed to arrive at a composite score for an application. Of note, the display medium for these questions may include an employer website linked to the web interface.

The score may quickly communicate to either or both the employer and prospective employee an indication of the applicant's appropriateness for a position. More particularly, the score speaks to the appropriateness in terms of the submitted employer criteria. The score/rating is typically formatted quantitatively by the program code. Such formatting may lend itself to speedy evaluation and subsequent processing. For instance, program code may automatically rank the score of the prospective employee in relation to other applicants. Program code may further initiate an action based upon the composite score. For instance, one embodiment may initiate sending of an email to the account of a prospective employee having a score exceeding 80 points out of a possible 100. Such automatically generated correspondence may include potential interview dates for the consideration of the prospective employee.

Another such communication may solicit references, writing samples and/or other information. In still another scenario, an employer may interact with the program code to initiate a display of only those applicants having a score ranking in the top 50. Thus, features of the present invention may function to further enable employers with regard to an ongoing recruitment process. In another or the same embodiment, the web-based program code may initiate an email transmission to the prospective employee and/or employer conveying the score of the applicant.

In this manner, embodiments of the present invention may accommodate and improve known recruitment practices by introducing program code configured to discriminate between prospective employers. For instance, employers may be unburdened with evaluating applicants who do not meet threshold criteria. Practices associated with suitable program code may be tailored to specific employer standards and criteria. Features of an embodiment consistent with the principles of the present invention may also reduce delays in responses and automate electronic filing and update procedures. For example, applicants may be provided instant feedback as to their prospective employability. Moreover, aspects of some embodiments may obviate expenses directed at costly advertisements and/or recruitment agencies ensures proper formatting.

Turning more particularly to the hardware of FIG. 5, the hardware configuration of the exemplary computer system 500 may focus hiring processes by providing program code 512 configured to discriminate between prospective employees. The system 500 may achieve such discrimination by subjecting a prospective employee to a second tier of evaluation processes only after an initial determination as to their employability has been achieved. One such system 500 may include a user computer 510 adapted to communicate with the network 508. As such, computer system 500 is illustrated as a networked system that includes one or more client computers 502, 504 and 510 (e.g., laptop, desktop or PC-based computers, workstations, etc.) coupled to server 506 (e.g., a PC-based server, a minicomputer, a midrange computer, a mainframe computer, etc.) through the network 508. Network 508 represents a networked interconnection, including, but not limited to local-area, wide-area, wireless, and public networks (e.g., the Internet). Moreover, any number of computers and other devices may be networked through network 508, e.g., multiple servers, which may double as client interfaces in some instances. Significantly, many suitable communication ports applicable to most network interfaces.

User computer 510, which may be similar to computers 502, 504, may include: a central processing unit (CPU) 511, a number of peripheral components such as a computer display 512, a storage device 513, a printer 514, and various input devices (e.g., a mouse 516, keyboard 517). Those skilled in the art will recognize that equipment compatible with the present invention is not limited to the exemplary devices shown in FIG. 5. Server computer 506 may be similarly configured, albeit typically with greater processing performance and storage capacity, as is well known in the art.

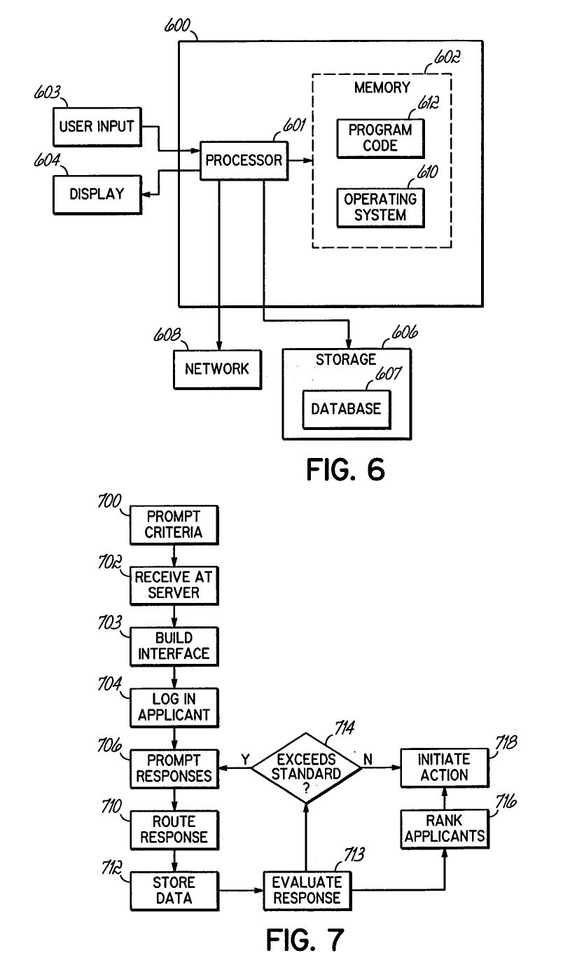

FIG. 6 illustrates a hardware and software environment for an apparatus 600 suited to conduct recruitment processes in a manner consistent with the above discussed principles. For the purposes of the invention, apparatus 600 may represent a computer, computer system or other programmable electronic device, including: a client computer (e.g., similar to computers 502, 504 and 510 of FIG. 5), a server computer (e.g., similar to server 506 of FIG. 5), a portable computer, an embedded controller, etc. Apparatus 600 will hereinafter also be referred to as a “computer,” although it should be appreciated the term “apparatus,” “system,” “server,” or “controller” may also include other suitable programmable electronic devices consistent with the invention.

Computer 600 typically includes at least one processor 601 coupled to a memory 602. Processor 601 may represent one or more processors (e.g., microprocessors), and memory 602 may represent the random access memory (RAM) devices comprising the main storage of computer 600, as well as any supplemental levels of memory, e.g., cache memories, non-volatile or backup memories (e.g., programmable or flash memories), read-only memories, etc. In addition, memory 602 may be considered to include memory storage physically located elsewhere in computer 600, e.g., any cache memory in a processor 601, as well as any storage capacity used as a virtual memory, e.g., as stored within a database 607 or on another computer coupled to computer 600 via network 608.

Computer 600 also may receive a number of inputs and outputs for communicating information externally. For interface with a user, computer 600 typically includes one or more input devices 603 (e.g., a keyboard, a mouse, a trackball, a joystick, a touchpad and/or a microphone, among others) and a display 604 (e.g., a CRT monitor, an LCD display panel, and/or a speaker, among others). It should be appreciated, however, that with some implementations of computer 600, e.g., some server implementations, direct user input and output may not be supported by the computer, and interface with the computer may be implemented through a client computer or workstation networked with computer 600.

For additional storage, computer 600 may also include one or more mass storage devices 606 configured to store a database 607. Exemplary mass storage devices 606 may include: a floppy or other removable disk drive, a hard disk drive, a direct access storage device (DASD), an optical drive (e.g., a CD drive, a DVD drive, etc.), and/or a tape drive, among others. Furthermore, computer 600 may include an interface with one or more networks 608 (e.g., a LAN, a WAN, a wireless network, and/or the Internet, among others) to permit the communication of information with other computers coupled to the network 608. It should be appreciated that computer 600 typically includes suitable analog and/or digital interfaces between processor 601 and each of components 602, 603, 604, 606 and 608.

Computer 600 may operate under the control of an operating system 610 and executes various computer software applications, components, programs, objects, modules, etc. Moreover, various applications, components, programs, objects, modules, etc., may also execute on one or more processors in another computer coupled to computer 600 via a network 608, e.g., in a distributed or client-server computing environment, whereby the processing required to implement the functions of a computer program may be allocated to multiple computers over a network 608.

In general, the routines executed to implement the embodiments of the invention, whether implemented as part of an operating system or a specific application, component, program, object, module or sequence of instructions are referred to herein as “computer programs,” or simply “programs” or “program code.” Furthermore, program code 612 may be interpreted as comprising multiple, distinct programs or algorithms used throughout an entire programmatic sequence or operation. The computer programs typically comprise one or more instructions that are resident at various times in various computer memory and storage devices. When a program is read and executed by a processor, the program causes the computer to execute steps or elements embodying the various aspects of the invention.

Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. Furthermore, those skilled in the art will recognize that the exemplary environments illustrated in FIGS. 1 and 5-6 are not intended to limit the present invention. Indeed, those skilled in the art will recognize that other alternative hardware and/or software environments may be used without departing from the scope of the invention.

The flowchart of FIG. 7 illustrates exemplary sequence steps initiated and/or executed by program code 612 within the above described hardware environments of FIGS. 1 and 5-6. At block 700, the program code 612 prompts the delivery of employer criteria to a client server at block 702. The server may simultaneously receive similar submissions from a plurality of employers typically competing or otherwise participating the same field of endeavor. For purposes of this disclosure, suitable employment criteria may include any stipulation or parameter relating directly or indirectly to requirements of a vacant position.

The employer typically submits the criteria to the server via the Internet using program code 612 suited to interface with a website. For instance, program code 612 at the employer's computer or executing at the client server may prompt the employer to submit certain criteria and other specifications. In one embodiment, program code 612 may prompt the employer to include relative weights or a scaled value indicative of the relative importance of the criteria at block 700. Such information may have application in later rating an applicant. Similarly, the program code may prompt an employer at block 700 to submit factors indicative of the relative value of potential responses submitted by prospective employees. Program code 612 available to an employer may additionally generate a generic criteria template to assist the employer in establishing their own more tailored criteria set.

The client server may subsequently receive, store and otherwise process the employment criteria. In one embodiment, the program code 612 incident at the server may construct web interfaces from and in response to the submitted criteria at block 702. One such interface may feature a composite matrix or other listing of core competency questions sampled from criteria submitted by employers across the industry. Such a listing may include those questions resonating throughout the entire industry. As such, the program code 612 may construct at block 702 a listing of core questions from those questions that were submitted by all or most employers. Such incidences of commonality may be numerous by virtue of the employers participating in the same field. The composite listing of core competency questions may function as an initial litmus test for prospective employees, gauging their qualifications against a threshold preset by a designated employer.

To this end, program code 612 may construct fields of the interface at block 703 in such a manner as they correspond to questions and responses weighted according to the submitted employer criteria. Program code 612 may process the multiplier information to arrive at a product. This product may comprise a score or other rating useful in evaluating applicant responses against the threshold value. As discussed herein, should an applicant's score meet or exceed the threshold, program code 612 may present the prospective employer with a different display and additional questions. To this end, subsequent lists, or tiers, of questions may be generated by the program code 612 at block 703.

Where desired, the font, colors and other presentation considerations associated with the display of these additional layers of question may be configurable by the employer via the program code 612 at block 702. To assist an employer as such, program code 612 may retrieve a generic or preselected template chosen by the employer. As discussed herein, program code 612 nonetheless may transparently ensure that fields of the template correspond to data fields in which the employer submitted their criteria. As such, the program code 612 may post the criteria as appropriate within the template. Such fields may programmatically link to mathematical weights, scaled values and factors useful in later grading applicant responses. Of note, flexibility of the program code 612 may enable automated restructuring and updating of web interfaces to reflect changing needs of an employer. Thus, features of an embodiment of the present invention cater to particular desires and time lines of users.

Program code 612 may enable a prospective employee may log into the Internet or other network at block 704. The accessibility of the Internet may lend particular application to certain recruiting scenarios. The employee may, more particularly, access the web interface constructed at block 703. The web interface may prompt the employee to submit answers and other data at block 706 in response to a display of core questions. Of note, the electronic nature of the data may applicant responses to be stored and promoted to multiple database fields simultaneously. Such a feature may eliminate need for the applicant to enter of redundant information.

Updated answers to core (and second tier) questions may be similarly entered and automatically realized using program code 612 incident at the server. Such ease of entry may encourage updates and qualified placements, while automatically initiating calculation of a new rating useful in assessing an applicant. In certain embodiments, prospective employees may direct to which employers their data is sent. For instance, a single entry of employee data may be simultaneously sent to multiple employers. Notably, the data may be automatically formatted in accordance with particular format requirements for each prospective employer.

Other features of an embodiment consistent with the invention may allow a prospective employee to effectively block transmission of information to certain, non-designated employers that the applicant is not interested in working for. This feature may help to eliminate incidences of an unwilling employee unwittingly applying for a job and wasting the possible employer's time. Automated features of another or the same embodiment consistent with the invention may further ensure that all required data is submitted by a prospective employee at the web interface before the data is transmitted to the server for evaluation. This feature may ensure that an employer is allowed to completely evaluate applicants without having to find out later that key information was missing or unacceptably presented. Still another feature may allow prospective employees to be flexibly billed for services provided at the server via their account. For instance, one embodiment may only charge applicants for maintenance of the account, or for designating over a preset number of employers. For example, it may be advantageous to charge an account of a prospective employee only if the applicant designates two or more employers.

At block 710, program code 612 may route the submitted responses to the core questions to the server. The data may be stored at block 712 for further processing, updates and other future use. Program code 612 may determine a rating for a prospective employee based upon the submitted data at block 713. One embodiment consistent with the invention may recall a matrixing algorithm configured to multiply a scaled value assigned to an employment criterion to a factor assigned to an employee response. To this end, program code 612 may enable an employer may assign scaled values correlated to the employment criteria submitted at block 700. The scaled values may be disproportionately weighted to reflect their relative importance. For instance, criteria relating to educational background may be weighted at a fraction of a scaled value assigned to a database field prompting work experience. Such a scenario may be desirable where an employer values work experience more than academic qualifications.

Similarly, an embodiment consistent with the present invention may automatically assign or prompt assignment of scaling factors to potential responses. For example, potential responses to an employment criterion may comprise a selection between four choices. Each selection of the four may be assigned a different factor useful in calculating an overall rating. As such, the program code 612 may calculate and assign a score to a prospective employee based upon their responses to the core questions. Of note, such a score may be automatically updated to reflect new data entered at the web server interface by the prospective employer.

At block 714, such a score may be compared against a threshold value. Suitable threshold values may be preset by an employer. In one embodiment, the threshold value may be adjusted in response to employer input to the server. As such, the employer may configure the threshold value to achieve a desired distribution of qualifying applicants. Scores falling below the threshold value may be designated as unacceptable at block 714. Applicants receiving such a deficient score may be notified immediately at block 718. For instance, an applicant having a rating below that of a threshold standard preset by the employer may result in initiation of an automatic email notification informing the prospective employee of their apparent incompatibility. Of note, suitable threshold criteria may relate to a binary response or single response and is not limited to evaluation of a rating. For instance, an employer may require an employee to live in a specific geographic area. An indicated unwillingness of an applicant to live in that area may effectively terminate consideration, irrespective of other considerations or scores. Of note, such a determination may involve the threshold indicator field having it on its own scale, altogether.

Those prospective employees having scores calculated at block 714 that exceed the threshold may be presented with further questions and/or employer-specific interfaces at block 706. Responses to these second tier questions and tasks may be similarly rated or otherwise evaluated at block 713. Such a score may be reported to either or both the employer(s) and prospective employee. For instance, ranking determined at block 716 may be displayed to the prospective employee at the terminal from which they access their account. In another embodiment, an employer may specify that they wish only to be informed of those applicants achieving scores ranking in the top percentile of an applicant pool. Thus, the rating may convey a standardized watermark to a prospective employer that allows more focused and efficient evaluation. The program code 612 may further rank applicants as between each other or some company standard. Thus, the rating may quickly communicate status and/or hiring potential of prospective applicants.

At block 718, program code 612 may initiate an action to the data prompted at block 706. For instance, software may automatically generate a response to an employee. The response may be gleaned directly from the associated rating of the prospective employee. A more generic response may merely acknowledge receipt of the application and convey their relative ranking of information concerning hiring of personnel for the potential vacancy. Another automatically generated response mechanism may prompt for more data. Such a scenario may have application where an employer only wishes to consider specific professional information for those applicants first exceeding a particular score or having a particular registerable attribute.

Still other actions taken in response to a calculated rating may include transmitting an electronic file, generating an online form, initiating capture of audio data and/or initiating capture of image data. Such captured data may have particular application in an online testing scenario. A high rating may initiate generation of an electronic mail response stating, “A personnel expert will be contacting you within 24 hours.” Where desirable, an employer may wish to be constantly updated as to qualified applicant entries. Another or the same configuration may forward to an employer only data meeting a certain requirement. Such a feature can relieve employers from the burden of evaluating less desirable applicants.

One skilled in the art should appreciate that the steps illustrated in the flowchart of FIG. 7 are ordered as shown for illustrative purposes and should not be construed in any way to limit the sequence that the same or equivalent steps can be executed in accordance with the underlying principles of the present invention. Such modifications may vary according to employer or administrator preference. Thus, benefits of embodiments of the present invention may include, but are not limited to the level of control afforded employers throughout a hiring process. By focusing the applicant pool on those prospective employers having discriminating qualifications, a web interface and system is provided which centralizes and comprehensively addresses all aspects of a recruitment process.

The flexible program interface may further allow the employer to specify the scope of a hiring process, to include the qualifications and the number of applicants to be considered. Employers and/or employees may even drive processes associated with an embodiment of the invention by initiating an application process or a search of an existing applicant pool. The web interface accessible to the employer may further incorporate additional software configured to scan, electronically file and store interview notes, applicant submitted documents and scoring data. Online examination software may be accessed by employers, while program code 612 may additionally analyze trends derived from submitted applicants. For instance, program code 612 may initiate generation of a report configured to communicate a demographic or other statistic descriptive of and/or otherwise determinable from input data. Embodiments of the present invention may further include software configured to realize automated notifications and accommodate known encryption techniques.

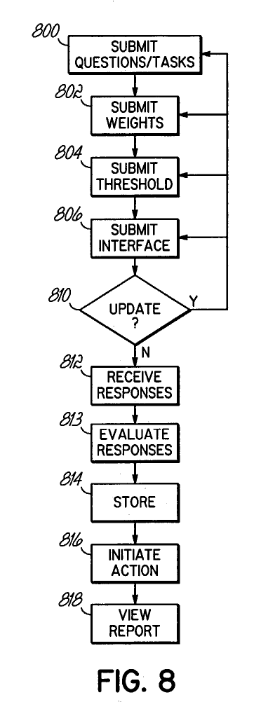

FIG. 8 is flowchart outlining exemplary method steps initiated by a prospective employer via the program code processes of FIG. 7 and within the hardware systems of FIGS. 1 and 5-6. At blocks 800-806, one or more employers submit criteria to a client server. As above, suitable employment criteria may include any stipulation or parameter relating directly or indirectly to requirements of a vacant position. For instance, an employer may submit a list of questions and/or tasks at block 800. An exemplary tasking may prompt submission of a writing sample or include an online test, such as a psychological profile examination. Certain of such questions/tasks submitted at block 800 may be included with core questions as determined and compiled by program code 612 consistent with the invention.

The employer may include relative weights or a scaled value indicative of the relative importance of the questions and other criteria at block 802. Such scaling information may be used to later rate an applicant. As such, the employer at block 802 may submit factors indicative of the relative value of potential responses submitted by prospective employees. To this end, the employer may indicate a threshold value at block 804 used to screen or otherwise evaluate prospective employees. To facilitate submission of data, the employer may use a generic criteria template to assist the employer in establishing their own more tailored criteria set.

Still other exemplary criteria submitted at block 805 may enable the employer to specify the scope of a hiring process, to include the qualifications and the number of applicants to be considered. Employers may even steer processes associated with an embodiment consistent with the invention by initiating an application process or a search of an existing applicant pool.

The employer typically submits the criteria to the server via a network suited to interface with a website. The employer may input data at block 806 suited to configure the font, colors and other presentation considerations associated with the website display. To assist an employer as such, program code 612 may retrieve a generic or preselected template chosen by the employer and having fields that correspond to data fields in which the employer submitted their criteria. Any criteria submitted at exemplary blocks 800-806, which are by no means intended to be an exhaustive list of available criteria, may be updated by an employer at block 810.

At block 812, an employer may receive responses from prospective employees. Such responses may include a ranking, as well as only responses from those employees meeting the above-discussed threshold requirements. The employer may manually and/or automatically evaluate the responses at block 813. Where desired, the employer may store the responses at block 814 for further processing, updates and other future use.

Such future use may include an action initiated at block 816. For instance, the employer may specify that software automatically generate a response to an employee whom meets a threshold criteria. As such, the response may be gleaned directly from the associated rating of the prospective employee. Another automatically generated response mechanism may prompt for more data. Still other actions taken in response to a calculated rating may include transmitting an electronic file, generating an online form, initiating capture of audio data and/or initiating capture of image data. Such captured data may have particular application in an online testing scenario. Employers are typically updated constantly as to qualified applicant entries. Stored data at block 814 may also include scanned interview notes, applicant submitted documents, exams and scoring data.

Where desired, an employer may analyze at block 818 trends derived from submitted applicants. For instance, the employer may evaluate a report communicating a demographic or other statistic descriptive of and/or otherwise determinable from input data.

One skilled in the art should appreciate that the steps illustrated in the flowchart of FIG. 8 are ordered as shown for illustrative purposes and should not be construed in any way to limit the sequence that the same or equivalent steps can be executed in accordance with the underlying principles of the present invention. Such modifications may vary according to employer or administrator preference.

While the present invention has been illustrated by a description of various embodiments and while these embodiments have been described in considerable detail, it is not the intention of the applicants to restrict or in any way limit the scope of the appended claims to such detail. For instance, one of skill in the art and having the benefit of this disclosure will appreciate that any of the functions described in connection with FIGS. 1 and 5-6 may be implemented using software. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A computer implemented method for recruiting, comprising:
receiving data submitted by a prospective employee at a web-based interface;
determining a score from the data;
comparing the score against a threshold value; and
if the score at least equals the threshold value, prompting additional data from the prospective employee.

2. The method according to claim 1, further comprising receiving an employment criterion at a server.

3. The method according to claim 2, wherein receiving the employment criterion further includes receiving a scaled value assigned to the employment criterion.

4. The method according to claim 2, wherein receiving the employment criterion further includes prompting the employment criterion.

5. The method according to claim 2, wherein receiving the employment criterion further includes prompting assignment of the scaled value.

6. The method according to claim 2, further comprising programmatically constructing the web-based interface to include the employment criterion.

7. The method according to claim 6, wherein constructing the web-based interface having the employment criterion further includes retrieving a stored design template relating to a layout of the web-based interface.

8. The method according to claim 2, wherein receiving employment criterion at the server further includes receiving an updated employment criterion.

9. The method according to claim 2, wherein constructing the web-based interface having the employment criterion further includes maintaining the web-based interface.

10. The method according to claim 1, wherein receiving the data further includes formatting the data in accordance with an employer standard.

11. The method according to claim 1, wherein receiving the data further includes providing the data to a designated employer and not to a blocked employer.

12. The method according to claim 1, wherein receiving the data further includes receiving information previously submitted by the prospective employee and promoted to the web-based interface.

13. The method according to claim 1, further comprising storing information related to the data.

14. The method according to claim 1, wherein if the score fails to equal the threshold value, further comprising prompting no additional data from the prospective employee.

15. The method according to claim 1, wherein prompting the additional data further includes selecting the action from a group consisting of: notifying the prospective employee of an employment status, notifying an employer of an employee status, prompting more data, arranging a personal interview, initiating an examination, initiating a task, transmitting an electronic mail message, transmitting an electronic file, generating an online form, initiating capture of audio data, initiating capture of image data and some combination thereof.

16. The method of according to claim 1, wherein receiving the data from the prospective employee at the web-based interface further includes assigning a factor to the data.

17. The method according to claim 1, wherein receiving the data from the prospective employee at the web-based interface further includes formatting the data to be compatible with the web-based interface.

18. The method according to claim 1, wherein receiving the data from the prospective employee at the web-based interface further includes receiving input selected from a group consisting of: a psychological examination, a digital image, an online examination, a scanned document, a photograph, an audio submission, a typed entry and some combination thereof.

19. The method according to claim 1, wherein receiving the data from the prospective employee at the web-based interface further includes receiving updated data.

20. The method according to claim 1, wherein determining the score further includes multiplying a factor by a scaled value.

21. The method according to claim 1, wherein determining the score further includes assigning a score to the data.

22. The method according to claim 1, wherein determining the score further includes ranking the data in relation to other rated data.

23. The method according to claim 1, further comprising generating a report descriptive of the data.

24. The method according to claim 1, wherein comparing the score against a threshold value further includes modifying the threshold value.

25. A computer implemented method for recruiting, comprising:
receiving input from a prospective employee designating at least one employer of a plurality of employers as being approved to receive data submitted by the prospective employee;
permitting the at least one employer to view the data; and
preventing at least a second employer of the plurality of employers from viewing the data.

26. A computer implemented method for recruiting, comprising:
permitting a prospective employee to apply to an initial employer via a web-based interface, wherein no charge is applied to an account associated with the prospective employee in consideration of the permission;
receiving input from the prospective employee indicating a desire to apply to an additional employer;
permitting the prospective employee to apply to the additional employer; and
charging the account.

27. An apparatus, comprising:
a computer in communication with a network; and
program code configured to receive data submitted by a prospective employee to the network, the program code being further configured to determine a score from the data, to compare the score to a threshold value, and if the score at least equals the threshold value, to prompt additional data from the prospective employee.

28. The apparatus according to claim 27, wherein the data includes an employment criterion.

29. The apparatus according to claim 28, wherein the data includes a scaled value assigned to the employment criterion.

30. The apparatus according to claim 29, wherein the program code initiates prompting assignment of the scaled value.

31. The apparatus according to claim 28, wherein the program code initiates prompting the employment criterion.

32. The apparatus according to claim 28, wherein the program code initiates construction of a web-based interface that includes the employment criterion.

33. The apparatus according to claim 32, wherein the program code initiates retrieving a stored design template relating to a layout of the web-based interface.

34. The apparatus according to claim 32, wherein the program code initiates maintenance of the web-based interface.

35. The apparatus according to claim 27, wherein the data further includes an updated employment criterion.

36. The apparatus according to claim 27, wherein the program code initiates formatting the data in accordance with an employer standard.

37. The apparatus according to claim 27, wherein the program code initiates storing information related to the data.

38. The apparatus according to claim 27, wherein the program code initiates providing the data to a designated employer and not to a blocked employer.

39. The apparatus according to claim 27, wherein the data includes information previously submitted by the prospective employee and promoted to the network.

40. The apparatus according to claim 27, wherein the program code is further configured to initiate an action from a group consisting of: notifying the prospective employee of an employment status, notifying an employer of an employee status, prompting more data, arranging a personal interview, initiating an examination, initiating a task, transmitting an electronic mail message, transmitting an electronic file, generating an online form, initiating capture of audio data, initiating capture of image data, and some combination thereof.

41. The apparatus according to claim 27, wherein the program code prompts no further data from the prospective employee in response to determining that the score fails to equal the threshold value.

42. The apparatus of according to claim 27, wherein the program code initiates assigning a factor to the data.

43. The apparatus according to claim 27, wherein the program code initiates multiplying a factor by a scaled value.

44. The apparatus according to claim 27, wherein the program code initiates assigning a score to the data.

45. The apparatus according to claim 27, wherein the data is selected from a group consisting of: a psychological examination, an online examination, a scanned document, a photograph, a sound submission, a digital image, a typed entry and some combination thereof.

46. The apparatus according to claim 27, wherein the program code initiates ranking the data in relation to other rated data.

47. The apparatus according to claim 27, wherein the program code initiates generating a report descriptive of the data.

48. The apparatus according to claim 27, wherein the program code initiates modifying the threshold value.

49. An apparatus, comprising:
a computer in communication with a network; and
program code configured to receive input from a prospective employee designating at least one employer of a plurality of employers as being approved to receive data submitted by the prospective employee; the program code being further configured to permit the at least one employer to view the data and to prevent at least a second employer of the plurality of employers from viewing the data.

50. An apparatus, comprising:
a computer in communication with a network; and
program code configured to permit a prospective employee to apply to an initial employer via the network, wherein no charge is applied to an account associated with the prospective employee in consideration of the permission; the program code being further configured to charge the account in response to permitting the prospective employee to apply to an additional employer; and
to charge the account.

51. A program product, comprising:
program code configured to receive data submitted by a prospective employee to a network, the program code being further configured to determine a score from the data, to compare the score to a threshold value, and if the score at least equals the threshold value, to prompt additional data from the prospective employee; and
a signal bearing medium bearing the program code.

52. The program product of claim 51, wherein the signal bearing medium includes at least one of a recordable medium and a transmission medium.
